(19) United States
(12) Patent Application Publication
(10) Pub. No.: US 2004/0081531 A1
(43) Pub. Date: Apr. 29, 2004

(54) Drum lug locking device

(76) Inventor: John Denison Keane, Athens, GA (US)

Correspondence Address: John D. Keane, 175 Hillcrest Avenue, Athens, GA, 30606, US

(21) Appl. No.: 10/280,269

(22) Filed: Oct. 28, 2002

(51) Int. Cl. F16B 39/10

(52) U.S. Cl. 411/119

(57) ABSTRACT

A locking device for preventing the loosening of a screw. The device consists of a flat strip of spring steel, the first end of which has an opening cut in a eight pointed star pattern for the purposes of slipping over and engaging the head of a screw. The second end is notched in such a way as to clip under the edge of a drum hoop when flexed downward by thumb pressure.

### FEDERALLY SPONSORED RESEARCH

Not Applicable

### SEQUENCE LISTING OR PROGRAM

Not Applicable

### BACKGROUND-FIELD OF INVENTION

The present invention is directed generally to a locking device and, in particuar, to a locking device which prevents the undesired loosening of a screw, particularly adapted for use, for example, in the tightening of a drum head on a drum using lug screws. This invention relates to musical drums, specifically to a device designed to prevent the drum lugs (also known as tensioning rods) from loosening due to vibration during a performance.

In the past, drum lugs have been employed and adjusted to produce selected tensioning of drum heads. Such adjusting is typically effected by tightening rotating lugs to produce desired drum head stretching, or tension. Such rotation adjusts the screw thread connection of the lugs with lug nuts located at the outer side of the drum body. In many applications, it is desired to prevent the undesired loosening of a screw which is used to tighten or adjust one element or work piece with respect to another element or work piece. Often, vibration or other environmental factors cause the screw or other fastening means to loosen causing unwanted effects. For example, the head of a musical drum is selectively tightened on the shell or body of the drum by means of lug screws to place the desired tension on the drum head. Once set, vibration caused by beating on the drum may cause loosening of the lug screws.

In such a drum construction, a plurality of lug nuts are secured around the outer circumference of the drum shell. Each lug nut includes a threaded opening therein. The drum head is secured to a rim or drum hoop which includes an opening in alignment with each of the lug nuts. A lug screw extends through each opening in the hoop and is threaded to a respective lug nut. The lug screw is tightened against the hoop to stretch the drum head to the desired degree. As a drummer plays the drum, the vibration causes the lug screw to loosen thereby requiring re-tightening of the drum head at relatively frequent and undesirable intervals.

Accordingly, it is desired to provide a locking device which engages the head of the lug and clips to the hoop in order to prevent loosening of the lug.

### BACKGROUND-DISCUSSION OF PRIOR ART

The design of this invention is radically different from other lug locking devices. One design titled “Screw Stabilizer” (U.S. Pat. No. 5,205,691 Steinberger, Apr. 27, 1993) consists of lugs equipped with miniature ball bearings that ride through a series of slopes to create the feeling of “click stops.” This design has proven ineffective for preventing drum lugs from loosening.

### OBJECTS AND ADVANTAGES

Under the current method, the head of a musical drum is tuned by adjusting drum tensioning rods, or “lugs” which pass through a metal drum hoop and are threaded into lug nuts which are fixed to the drum body. The drum hoop engages the periphery of the drum head, and stretches the head across the bearing edge of the drum body.

The lugs have a tendency to loosen due to vibration during normal playing of the instrument. The object of the new design of this invention is to lock the lugs in place to prevent them from loosening. This is accomplished with a locking device made of spring steel featuring a lug wrench at one end that fits over the head of the lug. At the other end a clip is provided that fits under the edge of the drum hoop. By pressing down on the thumb tab, the device is bent down towards the bottom of the drum hoop and the clip is placed under the edge of the drum hoop, thereby securing the lug with spring tension. The device fits the standard square-headed lugs found on most drums, and works on both top and bottom heads.

Once the device is attached to the drum hoop, it is virtually impossible for the lug to loosen on its own.

The main advantage of the new design is that drums equipped with this device will stay in tune throughout a performance, recording session, practice session, or other instance of sustained drumming.

Another advantage of the use of this device is extended drum head life. When drum heads become loose during a performance, they are more susceptible to denting and tearing while being struck with a drum stick. Moreover, constant loosening and re-tightening of the head reduces the elasticity of the head material, drastically shortening the life span of the drum head.

Also, the perfomer or technician is relieved of the time-consuming process of re-tuning the drums, which is especially inconvenient during a live performance.

### DESCRIPTION OF THE DRAWINGS

Further objects and advantages of this invention will become apparent from consideration of the drawings and ensuing description. For a fuller understanding of the invention, reference is had to the following description taken in connection with the accompanying drawings, in which:

FIG. 1 is a side view of a prior art drum.

FIG. 2 is a side view of the same drum showing the locking device (18) in operation.

FIG. 3 is a top view if the invention.

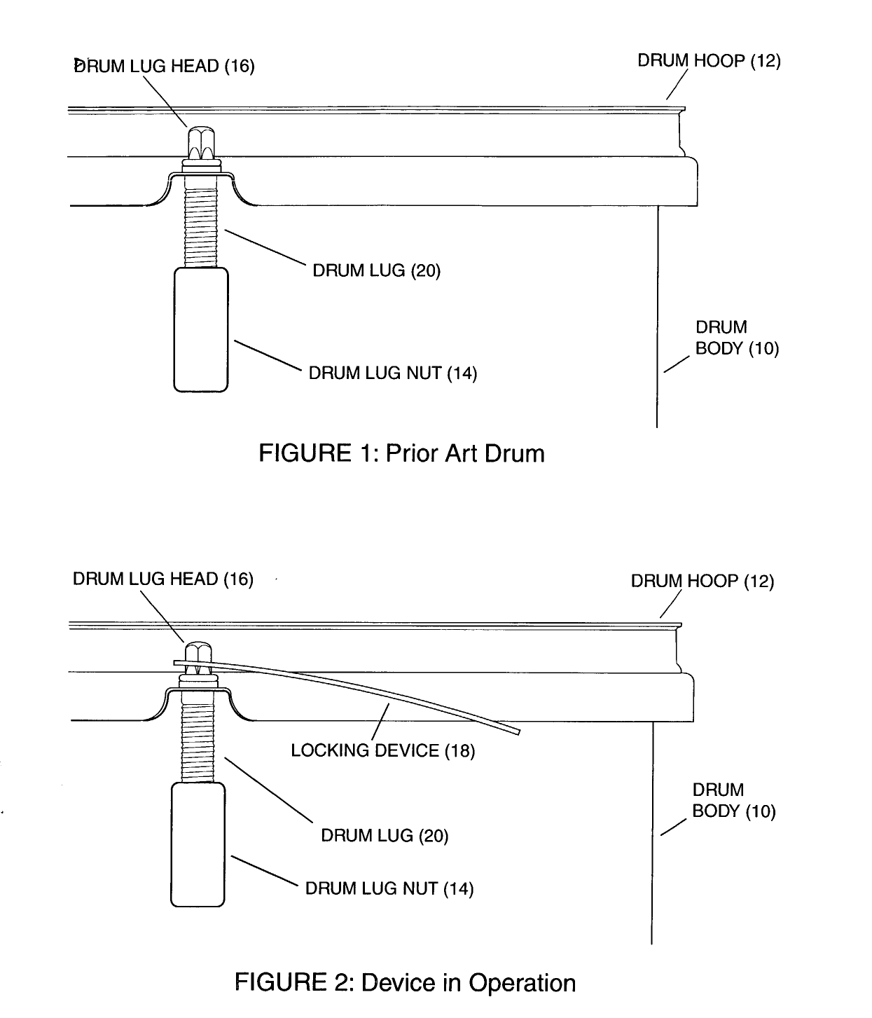

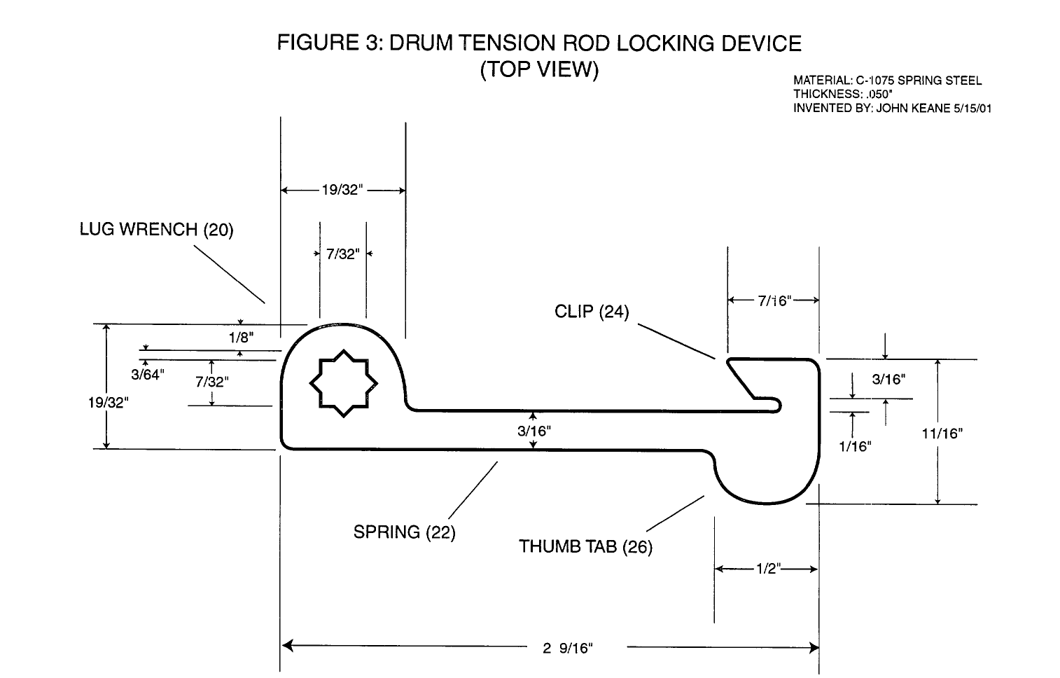

Further objects and advantages of this invention will become apparent from consideration of the drawings and ensuing description. FIG. 3 shows the design of the new invention. Please see FIG. 1 for current methods of securing intonation. FIG. 2 illustrates the device in operation.

### SUMMARY

Generally speaking, in accordance with the present invention, a locking device for securing drum lugs is provided. This invention solves the problems caused by the loosening of drum lugs during a performance. It offers a fixing device that will not allow the drum lugs to loosen, no matter how hard the drum is played.

Accordingly, it is an object of the present invention to provide a locking device.

Another object of the present invention is to provide a device for locking a lug or screw in a desired position.

A further object of the present invention is to provide a lug screw locking device which prevents the loosening of a drum head with respect to the body of a drum.

Yet another object is to provide multiple of such locking devices, for interaction with a series of lugs spaced about top and bottom drum hoops, and acting in concert to block unwanted changes in drum head tensioning.

Still other objects and advantages of the invention will in part be obvious and will in part be apparent from the specification.

The invention accordingly comprises the features of construction, combination of elements, and arrangement of parts which will be exemplified in the constructions hereinafter set forth, and the scope of the invention will be indicated in the claims.

### DETAILED DESCRIPTION OF THE PREFERRED EMBODIMENTS

For a fuller understanding of the invention, reference is had to the following description taken in connection with the accompanying drawings, in which:

FIG. 1 is a side view depicting a typical musical drum, which shows how lugs 20 and lug nuts 14 are used to fasten the drum hoop 12 to the drum body 10.

FIG. 2 is a side view depicting a typical musical drum with the locking device 18 in operation.

FIG. 3 shows a top view of the invention. The invention is comprised of a single, flat piece, preferably manufactured of C-1075 spring steel, with a thickness of 0.050 inches. The device has four main sections:

1. Lug Wrench 20—to be placed over the square head of a drum lug. The opening has an 8 point design to provide multiple options for positioning the wrench over the head.

2. Spring 22—a 1⅜″ length of flexible spring steel which allows the device to bend repeatedly without fatigue, and provides the spring tension which holds the device in place.

3. Clip 24—a V-shaped protrusion that fits under the edge or the drum hoop, thereby locking the device securely in place.

4. Thumb Tab 26—provided a place to press with the thumb for installation or removal of the device.

It is noted that the device is to be preferably manufactured from C-1075 spring steel. While the present invention has been described for use in connection with a drum, it is noted that the invention is applicable wherever it is desirable to prevent the loosening of a screw caused by vibration or the like. It is also noted that while the invention has been described with respect to only one drum lug, it would normally be provided on each of the plurality of lug screws around the drum shell periphery to prevent loosening of any of the lug screws which would otherwise have a deleterious effect on the drum sound.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense. It is also to be understood that the following claims are intended to cover all of the generic and specific features of the invention herein described and all statements of the scope of the invention which, as a matter of language, might be said to fall therebetween.

### OPERATION OF INVENTION

Installation of the device is as follows:

1. The Lug Wrench 20 is placed over the square head of the drum lug and slid down until it rests against the base of the drum lug head as in FIG. 2.

2. The Thumb Tab 26 is pressed with thumb pressure to bend the Spring 22 down.

3. The device is rotated slightly inward towards the body of the drum until the Clip 26 catches under the edge of the drum hoop, at which time it is released, thereby securing the device with spring tension.

Removal of the device is accomplished by applying the aforementioned steps in reverse.

1. A locking device for preventing the undesired loosening of the lug screw coupling the rim or hoop of a drum to the body of the drum, comprised of a flat length of spring steel with an eight pointed star shape cut into the first end for the purposes of fitting over the head of said lug screw, and a notched protrusion at the other end cut in such a way as to be capable of latching under the edge said drum hoop when the device is flexed.
